(19) United States
(12) Patent Application Publication
(10) Pub. No.: US 2008/0061463 A1
(43) Pub. Date: Mar. 13, 2008

(54) Method and Device for Making Polymer Foam Beads or Balloons

(75) Inventors: Lyonel Guillot, Talant (FR); Patrick Vedrenne, Dijon (FR); Jocelyne Etheve, Gilles Les Bains (FR)

Correspondence Address: HUTCHISON LAW GROUP PLLC, PO BOX 31686, RALEIGH, NC, 27612, US

(73) Assignee: COMMISSARIAT A L'ENERGIE ATOMIQUE, Paris (FR)

(21) Appl. No.: 11/792,296

(22) PCT Filed: Dec. 7, 2005
(86) PCT No.: PCT/FR05/51050

§ 371 Date: Jun. 5, 2007

(30) Foreign Application Priority Data
Dec. 10, 2004 (FR) 0452929

(51) Int. Cl. C08J 9/28; B01J 13/12

(52) U.S. Cl. 264/53; 425/5

(57) ABSTRACT

The invention relates to a method and to a device for manufacturing polymer foam beads or balloons. This method comprises the following steps:
a) forming liquid beads with an organic phase, or liquid balloons by encapsulating an aqueous phase W₁ in an organic phase;
b) suspending the liquid beads or balloons in an aqueous phase W₂; c) subjecting the emulsion thus formed to a temperature θ that is at least equal to the temperature at which said initiator has a decomposition half-life of 5 to 15 minutes, but that is lower than the degradation temperature of the organic phase, for the time required for this phase to gel; and d) completing the solidification of the organic phase. Applications: manufacture of microballoons used especially for producing targets for the study of inertial confinement fusion, matrices intended for solid-phase syntheses, the specific immobilization of biological components of the protein type, or else the execution of high-throughput biological tests.

### TECHNICAL FIELD

The invention relates to a method for manufacturing polymer foam beads or balloons, and also to a device specially designed to implement this method.

In what follows and what has been said so far, the term “bead” is understood to mean a full sphere or quasi-sphere, whereas the term “balloon” is understood to mean a sphere or quasi-sphere comprising a central cavity bounded by a wall.

The method according to the invention makes it possible, in particular, to manufacture, with a high yield, polymer foam “microballoons”—that is to say balloons having a diameter from a few hundred micrometers to several millimeters—with perfectly controlled geometric characteristics (size, circularity, concentricity, etc.) and having pore sizes less than one micrometer.

These microballoons are especially used in the field of plasma physics, and in particular for producing targets for studying inertial confinement fusion, but they can also be used in other fields such as, for example, the manufacture of matrices for solid-phase syntheses, for specific immobilization of biological components of the protein type, or else for the execution of high-throughput biological tests.

### PRIOR ART

For producing targets for studying inertial confinement fusion phenomena, it is known to use polymer foam microballoons measuring one or more millimeters in diameter and having a wall thickness of around 30 to 500 microns, that are then filled with deuterium or with a mixture of deuterium and tritium by permeation through their wall.

These microballoons must meet a certain number of requirements and have, in particular, the most perfect circularity (or sphericity) and concentricity possible.

The most conventional route for manufacturing these microballoons consists firstly in forming these microballoons in a liquid form, by encapsulating a first aqueous phase in an organic phase containing both a crosslinkable monomer and a polymerization initiator, then in suspending the liquid microballoons thus formed in a second aqueous phase, with stirring, for the time required to solidify the organic phase by polymerizing the monomer present in this phase and crosslinking the resulting polymer.

After separating the microballoons from the second aqueous phase, the first aqueous phase encapsulated within the organic phase is replaced with a solvent that is more volatile than water, which is, in turn, removed by a drying operation, letting air take its place.

One of the difficulties posed by this manufacturing route lies in the instability of the emulsion formed by the liquid microballoons in suspension in the second aqueous phase. This is because this emulsion tends to degrade, especially by coalescence, flocculation and sedimentation mechanisms, before the organic phase of the microballoons has had time to gel, which results in the formation of agglomerates of microballoons that are subsequently unusable, and which especially upsets the manufacturing yield of these microballoons.

Until now, all the methods proposed for stabilizing this type of emulsion rely on chemical additives. Thus, for example, M. Tagaki et al. (J. Vac. Sci. Technol. A, 9, 820, 1991) resort to surfactants that they incorporate into each of the aqueous and organic phases.

However, within the scope of their work, these inventors have observed that by subjecting an emulsion of the type described above to a heat treatment under suitably chosen conditions, immediately after forming this emulsion, it is possible to sufficiently reduce the gelling time of the organic phase of the liquid microballoons so that this gelling takes place before the degradation mechanisms of the emulsion have had time to start. Thus, any risk of the liquid microballoons agglomerating together is removed.

Once the organic phase of the microballoons has gelled, the solidification of this phase and, consequently of the microballoons themselves, may then be completed conventionally.

It is on this observation that the present invention is based.

### SUMMARY OF THE INVENTION

A first subject of the invention is therefore a method for manufacturing polymer foam beads or balloons, comprising the following steps:
a) forming liquid beads with an organic phase, or liquid balloons by encapsulating an aqueous phase W₁ in an organic phase, this organic phase comprising at least one crosslinkable monomer and one initiator for polymerization in solution in an organic solvent immiscible with water;
b) forming an emulsion by suspending the liquid beads or balloons in an aqueous phase W₂;
c) subjecting the emulsion thus formed to a temperature θ that is at least equal to the temperature at which the polymerization initiator has a decomposition half-life of 5 to 15 minutes, but that is lower than the degradation temperature of the organic phase, for the time required for this organic phase to gel; and
d) completing the solidification of the organic phase of said beads or balloons.

Thus, according to the invention, the temperature θ to which the emulsion formed by the liquid beads or balloons in suspension in the aqueous phase W₂ is subjected is:
at least equal to the temperature at which the polymerization initiator present in the organic phase of these beads or balloons has a decomposition half-life of 5 to 15 minutes; while being
lower than the temperature at which this organic phase is capable of degrading.

Such a temperature makes it possible to activate, very rapidly, the polymerization and the crosslinking of the crosslinkable monomer present in the organic phase of the liquid beads or balloons, and to obtain the gelling of this phase before the degradation mechanisms of the emulsion formed by these beads or balloons in suspension in the aqueous phase W₂ have had, themselves, the time to begin.

The term “crosslinkable monomer” is understood to mean a polyfunctional monomer able to form polymer chains by polymerization, then to form a three-dimensional network by formation of bridges between these polymer chains, optionally via a crosslinking agent.

The term “degradation temperature of the organic phase” is understood to mean the temperature at which at least one of the constituent components of the organic phase of the beads or balloons, other than the polymerization initiator, is capable of degrading and of thus causing degradation of this organic phase throughout its entirety.

It should be noted that the decomposition half-life of initiators for polymerization in solution in the solvents and also their variations as a function of the temperature make up part of the technical information available from suppliers of this type of products. Thus, for example, Wako Pure Chemical Industries Ltd., who offer a wide range of polymerization initiators, make diagrams available to their customers that make it possible to determine the temperatures at which these initiators have half-lives of 5 to 15 minutes.

Furthermore, the degradation temperatures of the other constituents of the organic phase of the liquid beads or balloons themselves are available in the suppliers' catalogs or in works cataloging chemical products such as, for example, the Merck Index.

As a result, the range of temperatures θ able to be used during step c) may easily be determined.

According to the invention, step c) of the method is, preferably, carried out by making the emulsion flow in a duct heated to the temperature θ.

According to a first advantageous embodiment of the method according to the invention, in step b), the liquid beads or balloons are suspended in the aqueous phase W₂ while being separated from each other by an aqueous phase W₂ volume preventing them from coming into contact with each other.

Similarly, in step c), the liquid beads or balloons are advantageously kept separate from each other by an aqueous phase W₂ volume that is suitable for preventing any contact between these liquid beads or balloons.

Thus, any possibility of interaction between the liquid beads or balloons is removed as long as the organic phase has not gelled.

In practice, to implement these embodiments, the invention anticipates:
forming, in step a), the liquid beads or balloons in successive order at the outlet orifice of an injection system; then
suspending, in step b), these liquid beads or balloons in the aqueous phase W₂ by extracting them from the outlet orifice of this injection system, as they are formed, by means of an aqueous phase W₂ stream having a constant flow rate; and
carrying out step c) by making the emulsion resulting from the extraction of the liquid beads or balloons flow via the aqueous phase W₂ stream in a duct heated to the temperature θ.

According to another advantageous embodiment of the method according to the invention, step d) is carried out in a container into which the emulsion pours out after having traveled through said duct.

Indeed, once the organic phase has gelled, the beads or balloons may be collected in a shared container and the solidification of this phase may be continued and completed by keeping them in this container with gentle stirring.

According to the invention, the method comprises, in addition, after step d), a step of washing the beads or balloons, for example, with salt water, and a step of drying the beads or balloons thus washed.

Preferably, between the washing and drying steps, a step is inserted that consists in replacing the organic solvent present within the wall of the beads or balloons and, in the case of balloons, the aqueous phase W₁ present in these balloons, with a solvent that is more volatile than water, this solvent preferably being an alcohol and, in particular, ethanol.

In any case, drying of the beads or balloons is, preferably, carried out with supercritical CO₂.

If it is desired to obtain beads or balloons having the most perfect circularity and, in the case of balloons, concentricity properties possible, it is necessary to control the densities of the various aqueous phases and the organic phase.

Thus, for a good circularity, it is advisable that the density of the aqueous phase W₂ be relatively close to the bulk density of the liquid beads or balloons, that is to say to the density of the organic phase in the case of beads, and to the density of the group formed by the organic phase and the aqueous phase W₁, while being greater than this bulk density, otherwise an emulsion would be hard to obtain.

Similarly, for a good concentricity, it is advisable that the density of the organic phase be greater than, while being not very different from, the density of the aqueous phase W₁.

Thus, according to the invention, it is preferred for the aqueous phase W₂ to have a density that is at most 1% greater than the bulk density of the liquid beads or balloons and, in the case of manufacturing balloons, for the organic phase to have a density that is at most 1% greater than the density of the aqueous phase W₁.

The constituents of the aqueous phase W₂, of the organic phase and, in the case of manufacturing balloons, of the aqueous phase W₁, and also their respective amounts, are therefore chosen accordingly.

According to yet another advantageous embodiment of the method according to the invention, the crosslinkable monomer(s) present in the organic phase is(are) radical-polymerizing monomer(s), in which case it(they) is(are) advantageously chosen from multifunctional acrylates and methacrylates. It(they) may especially be trimethylolpropane triacrylate (TMPTA), pentaerythrol triacrylate (PETA), trimethylolpropane trimethacrylate (TMPTMA), trimethylolpropane ethoxylate triacrylate, trimethylolpropane propoxylate triacrylate or tripropylene glycol diacrylate, the TMPTMA being particularly preferred.

Other types of crosslinkable monomers are also able to be used such as, for example, styrenic monomers: divinylbenzene, trivinylbenzene, divinylnaphthalene, divinylalkylbenzene and similar monomers.

Also in this case, the polymerization initiator is, preferably, chosen from azo-type radical polymerization initiators that are soluble in the organic solvents such as, for example, α,α′-azobisisobutyronitrile or 2,2′-azobis(4-methoxy-2,4-dimethylvaleronitrile).

The method according to the invention has many advantages.

Specifically, it makes it possible to manufacture, with a high yield, polymer foam beads or balloons having a very homogeneous structure and with perfectly controlled geometric characteristics, especially circularity and, in the case of balloons, concentricity.

Therefore, it is particularly well suited to manufacturing polymer foam microballoons intended to be incorporated into the composition of targets for studying inertial confinement fusion.

The method according to the invention has, in addition, the advantage of being able to be implemented using a relatively simple and low-cost device.

Therefore, another subject of the invention is a device specially designed to implement a method as defined previously, this device comprising:
an injection system comprising one or more inlets for supplying it with organic phase and optionally with aqueous phase W₁, and an outlet orifice for forming the liquid beads or balloons;
a closed chamber in which the outlet orifice of the injection system is housed, this chamber comprising one or more inlets for supplying it with aqueous phase W₂ and an outlet for evacuating from this chamber the emulsion resulting from the suspension of the liquid beads or balloons in this aqueous phase W₂;
a coil for subjecting the emulsion to the temperature θ, this coil comprising an inlet connected to the chamber outlet and an outlet, and being equipped with heating means; and
means for receiving the emulsion at the outlet of said coil.

According to a first advantageous embodiment of this device, the outlet of the chamber is composed of a tubing of which one end is located opposite and close to the outlet orifice of the injection system, and of which the other end is connected to the coil.

According to another advantageous embodiment of this device, the coil is formed by a tube wound spirally around a vertical axis, the turns of which are preferably touching.

According to yet another advantageous embodiment of this device, the coil is housed in a closed chamber equipped with an inlet and an outlet for supplying it with a heat transfer fluid suitable for providing the heating of this coil.

Preferably, the coil and the chamber in which is it housed are made of glass.

The invention will be better understood on reading the remainder of the description that follows, which relates to an exemplary device enabling polymer foam microballoons to be produced by the method according to the invention and also to an exemplary implementation of the method according to the invention for producing polymer foam microballoons using this device, and which refers to the appended drawings.

It goes without saying that these examples are only given as illustrations of the invention and in no way constitute a limitation thereof.

### BRIEF DESCRIPTION OF THE DRAWINGS

FIG. 1 schematically represents an exemplary device enabling polymer foam microballoons to be produced by the method according to the invention.

FIG. 2 represents an image taken with a CCD camera showing the formation of a liquid microballoon during the method according to the invention.

FIG. 3 shows, in the form of a histogram, the distribution of polymer foam microballoons produced by the method according to the invention as a function of their diameter, expressed in microns.

FIG. 4 represents the line of deviation from circularity of polymer foam microballoons produced by the method according to the invention.

FIG. 5 represents two X-ray radiography images showing the wall of a polymer foam microballoon produced by the method according to the invention, the part A corresponding to a 4× magnification and the part B corresponding to a 10× magnification.

FIG. 6 represents three images, taken with a scanning electron microscope at a magnification of 40,000×, of a polymer foam microballoon produced by the method according to the invention, the part A corresponding to a view of the external surface of the wall of this microballoon, the part B corresponding to a view of the wall at the boundary with the internal surface (upper left part of the image), and the part C corresponding to the internal surface of this wall.

### EXAMPLES

### Example 1

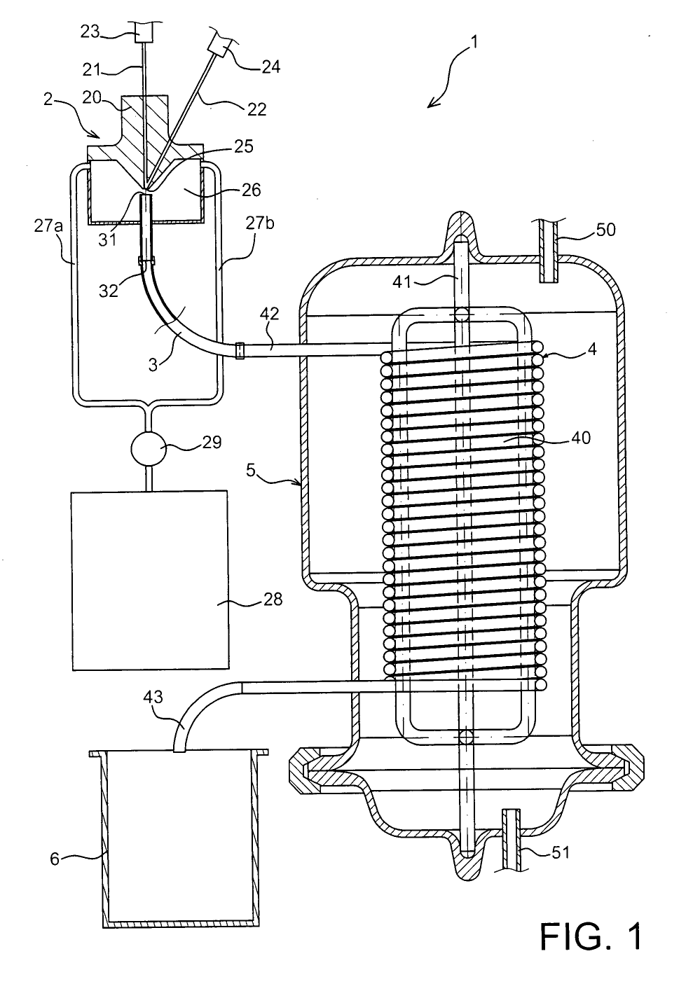

Reference is firstly made to FIG. 1 that schematically represents an exemplary device enabling polymer foam microballoons to be produced by the method according to the invention.

As can be seen in this figure, this device, which is referenced 1, mainly comprises a three-phase injector 2, a coil 4 that is connected to this injector via a connection 3 and that is housed in a closed chamber 5, and a container 6.

The three-phase injector 2 firstly comprises an injection system 20 whose role is to ensure, under operating conditions, the formation of liquid microballoons by encapsulating an aqueous phase W₁ in an organic phase containing at least one multifunctional monomer and one polymerization initiator.

This injection system, which may be produced in any way known to a person skilled in the art of encapsulating of one liquid phase in another liquid phase, comprises at least two capillaries 21 and 22 of which one end is connected to a system, 23 and 24 respectively, enabling these capillaries to be supplied, continuously and at constant flow rate, firstly with an aqueous phase W₁ and secondly with an organic phase, while their other end emerges into a shared outlet orifice 25 at which the liquid microballoons are formed.

As means of supplying the capillaries 21 and 22, syringes may especially be used, for example gas syringes, the flow rate of which is controlled using a syringe driver.

The three-phase injector 2 also comprises a closed chamber 26 that is located just below the injection system 20 so that the outlet orifice 25 of this system emerges into this chamber.

Under operating conditions, this chamber is, itself, supplied with a continuous stream and constant flow rate of an aqueous phase W₂ thanks to two ducts 27a and 27b, one end of which emerges into this chamber and the other end of which is connected to a tank 28 previously filled with this aqueous phase.

This tank is advantageously equipped with a heating system (not shown in FIG. 1) enabling the aqueous phase W₂ that it contains to be heated to an intermediate temperature between room temperature and the temperature at which gelling of the organic phase of the liquid microballoons is capable of starting.

The supply of aqueous phase W₂ to the chamber 26 via the lines 27a and 27b is advantageously controlled by a pump 29 such as, for example, a peristaltic pump.

As can be seen in FIG. 1, also emerging into the chamber 26 is tubing 30 of which one end 31 is located opposite and close to the outlet orifice 25 of the injection system 20, and of which the other end 32 is connected to the coil 4 via the connection 3.

Thus, under operating conditions, the pressure exerted by the aqueous phase W₂ flowing in the chamber 26 on the liquid microballoons formed successively at the outlet orifice 25 of the injection system 20 has the effect of extracting these liquid microballoons from this orifice as they are being formed and, similarly, of suspending them in this phase, which results in the formation of a water-in-oil-in-water triple emulsion.

In addition, considering, on the one hand, the continuous supply of the aqueous phase W₂ at a constant flow rate to the chamber 26 and, on the other hand, the alignment of the end 31 of the tubing 30 onto the outlet orifice 25 of the injection system 20 and the proximity existing between this end and this orifice, the liquid microballoons thus extracted are immediately entrained by the aqueous phase W₂ stream into the tubing 30 in the direction of the coil 4, while being separated from each other by a liquid volume that prevents them from coming into contact with each other, whether in this tubing or subsequently in the connection 3 or the coil 4.

This coil is formed by a tube 40 spirally wound around a vertical axis 41 that ensures it is held in position in the chamber 5, and of which the turns are preferably, but not compulsorily, touching, as shown in FIG. 1, so that the coil may have, for a given length of tube, the smallest possible height.

The coil 4 comprises an inlet 42 and an outlet 43 that are located outside the chamber 5, this inlet being connected to the tubing 30 of the three-phase injector 2 via the connection 3, and this outlet being positioned above and close to the opening of the container 6.

The chamber 5 also itself comprises an inlet 50 and an outlet 51 that are connected to a system (not shown in FIG. 1) suitable for providing a continuous flow of a heat transfer fluid, for example water, in this chamber making it possible to heat, under operating conditions, the coil 4 and, similarly, the emulsion that flows therein at the temperature θ chosen to gel the organic phase of the liquid microballoons in this coil, considering the time required for this emulsion to travel through this coil.

The system ensuring the circulation of the heat transfer fluid in the chamber 5 may, for example, be a circulating thermostatted bath of the type of those sold by Haake.

Of course, it is advisable that the coil 4 be made from a material having good heat conduction properties. It can, in addition, be appreciated that this material and that forming the chamber 5 be transparent in order to allow, under operating conditions, the progression of the emulsion in the coil 4 to be followed. Therefore, it is preferred that this coil and its chamber be made of glass, but other materials such as quartz or stainless steel can also be used.

The container 6, that is used, under operating conditions, to collect the emulsion exiting the coil 4, may itself be any device having a capacity suitable for the aqueous phase W₂ volume used, for example a beaker, which is advantageously equipped with a stirring system enabling the gelled microballoons to be maintained in suspension in this phase.

The use of the device 1 for manufacturing polymer foam microballoons is extremely simple.

Specifically, after having determined the temperature at which the coil 4 must be heated and the time during which the emulsion must stay in this coil so that gelling of the organic phase of the liquid micro-balloons is obtained without starting the degradation processes of the emulsion, the tank 28 is filled with aqueous phase W₂ and this tank as well as the coil 4 are heated to the desired temperatures.

Once these temperatures are reached, the supply of the chamber 26 of the three-phase injector 2 with aqueous phase W₂ is activated, the flow rate of which is controlled depending on the time that must be taken for the emulsion to travel through the coil 4.

Then, the capillaries 21 and 22 of the injection system 20 are simultaneously supplied with aqueous phase W₁ and organic phase respectively, controlling the flow rate of this supply as a function of the frequency at which it is desired that the liquid microballoons are formed.

This simultaneous injection results in the formation of liquid microballoons at the outlet orifice 25 of the injection system 20.

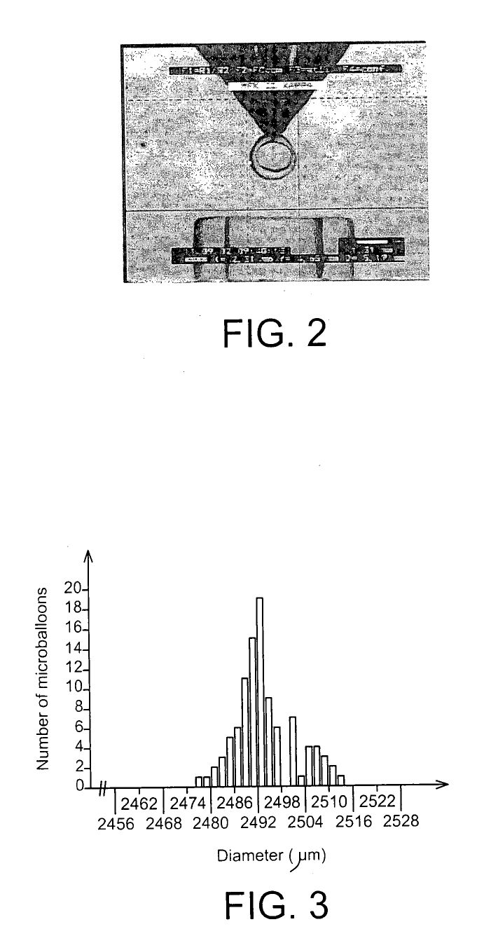

By way of example, the formation of a liquid microballoon is illustrated in FIG. 2 which represents an image taken using a CCD camera level with this outlet orifice.

As previously explained, the liquid microballoons are, as they are being formed, extracted from the outlet orifice 25 of the injection system 20 by the aqueous phase W₂ flowing in the chamber 26 of the three-phase injector 2, and are immediately entrained by it into the coil 4 that they travel through, while being separated from each other by an aqueous phase W₂ volume.

As they exit this coil, the gelled microballoons are recovered together with the aqueous phase W₂ in the container 6 where they are held, still in suspension in this phase, for the time required to complete the crosslinking and, consequently, the solidification of their organic phase.

### Example 2

Polymer foam microballoons having a desired average diameter of 2.5 mm and a desired average density of 250 mg/cm⁻³ were produced by the method according to the invention, as follows.

1) Preparation of the Aqueous Phases W₁ and W₂ and of the Organic Phase:

Aqueous Phase W₁:

In an Erlenmeyer flask, deuterium oxide (D₂O— Aldrich) was diluted in ultrapure water, having a resistivity equal to 18.2 MΩ, to obtain a solution having a D₂O weight content of 8.33% and a density equal to 1.01. This mixture continued to be stirred until use.

Aqueous Phase W₂:

88% hydrolyzed polyvinyl alcohol having a molecular weight equal to 25,000 g/mol (PVA—Polysciences) was introduced in small amounts into a reactor previously filled with 6 liters of ultrapure water having a resistivity equal to 18.2 MΩ=0 and subjected to a continuous mechanical stirring (100 rpm), in order to obtain a solution having a PVA weight content of 5%. After completely dissolving the PVA, the solution was filtered through a 0.45 μm Teflon® filter, after which it was put under a continuous vacuum for 48 hours at 40° C. Its density was 1.01.

Organic Phase:

Firstly, dibutyl phthalate (Aldrich) and ethylbenzene (Aldrich) were mixed in a volume ratio of 89:11 to obtain a solvent having a density equal to 1.02.

Then, this solvent was introduced into an Erlenmeyer flask containing an amount by weight of trimethylolpropane trimethacrylate (TMPTMA—Aldrich) that was a function of the density of the polymer foam that it was desired to obtain. Thus, for example, to obtain a polymer foam having a density approximately equal to 250 mg/cm³, the weight of TMPTMA had to be 125 mg per cm³ of solution.

Added to this mixture were an amount by weight of α,α′-azobisisobutyronitrile (AIBN—Acros Organics) corresponding to 10% of the weight of the TMPTMA dissolved in the solvent, then an amount by weight of sorbitan monooleate (Span 80—Aldrich) corresponding to 2.5% of the total weight of the organic phase thus prepared. The resulting solution was left stirring for 12 hours, then it was degassed at 0.25 bar for 30 minutes just before use.

2) Formation and Gelling of the Liquid Microballoons and Completion of the Crosslinking:

A device as described above was used having the following characteristics:
internal diameter of the capillary 21: 0.15 mm
internal diameter of the capillary 22 and of the outlet orifice 25: 0.45 mm;
internal diameter of the tubing 30, the connection 3 and the tube of the coil 4: 5 mm
material of the coil 4: borosilicate glass
length of the coil 4: 11 meters
container 6: beaker having pendular stirring (25 rpm).

In addition, the operating conditions below were used:
flow rate of the aqueous phase W₁: 8 μl/minute
flow rate of the organic phase: 4 μl/minute
flow rate of the aqueous phase W₂: 100 ml/minute
temperature of the aqueous phase W₂ in the tank 28: 40° C.
temperature of the coil 4: 95° C., corresponding to a half-life of the AIBN of around 10 minutes
time for the microballoons to travel through the coil 4: 2 minutes
residence time of the microballoons in the container 6: ≈1 hour.

3) Washing and Drying of the Microballoons

Once the crosslinking was completed, the microballoons were washed three times in water containing 10 g of NaCl per liter, with pendular stirring (25 rpm), after which they were immersed in 100% ethanol for 24 hours, still with pendular stirring (25 rpm).

They were then distributed in Teflon® pill dispensers and these pill dispensers were placed in a supercritical CO₂ dryer for 1 hour at 70° C. and under a pressure of 90 bar.

The microballoons thus produced were subjected to a series of analyses aiming to assess their diameter and their circularity, their wall thickness and their concentricity, their density and also their structure.

The diameter and the circularity of the microballoons were assessed using a telecentric microscope comprising a Pulnix™-1020×1020 camera. After calibrating this device with a reference bead, each balloon was measured individually.

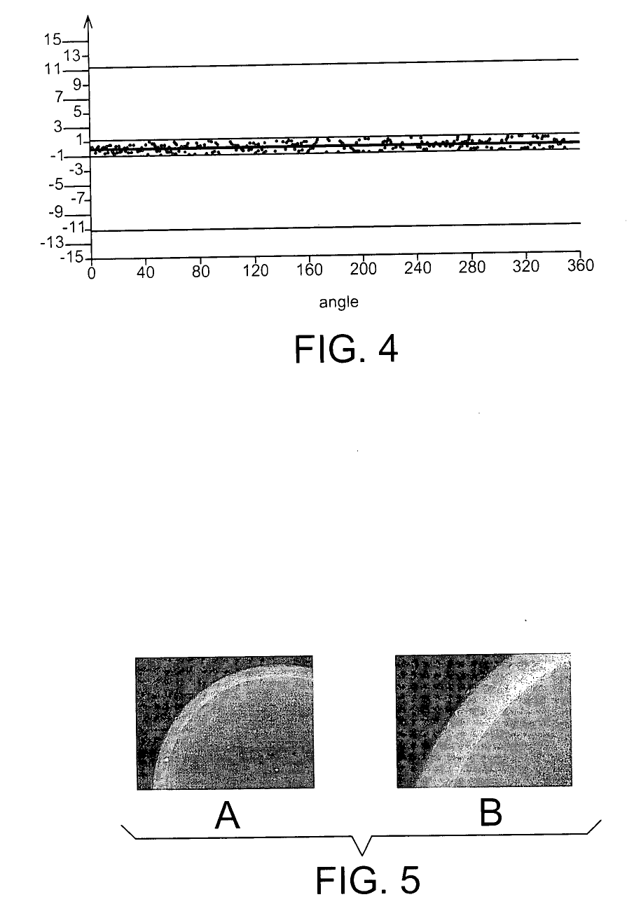

FIG. 3 represents, in the form of a histogram, the distribution of microballoons as a function of their diameter, expressed in microns, while FIG. 4 represents the line of deviation from circularity of these microballoons.

These figures show that the dispersion of the microballoons around the desired average diameter (2.5 mm) is ±20 μm, or a dispersion of less than 1%, and that the actual variation in their surface area (point on the line at 360°) relative to a perfect sphere whose profile would be represented by a straight line passing through 0, is very low.

After supercritical drying, the microballoons were opaque to visible light. Thus, the tests aiming to assess their wall thickness and their concentricity were carried out by X-ray radiography.

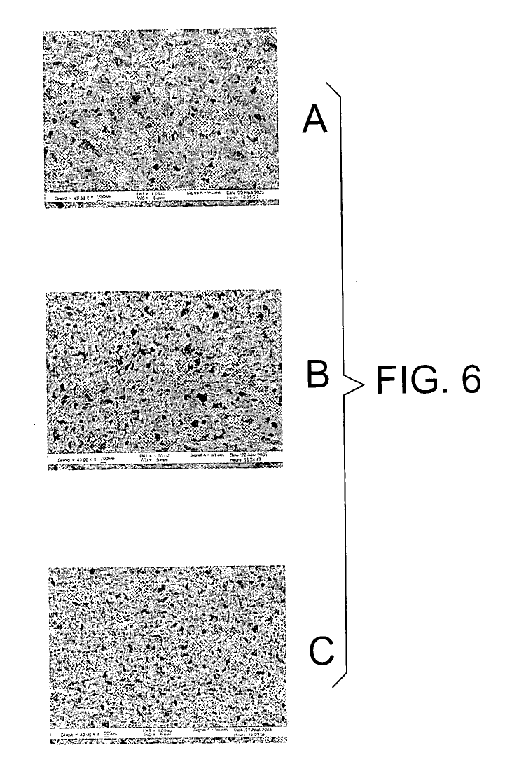

FIG. 5 shows two images thus obtained using X-rays, the part A corresponding to a magnification of 4× and the part B corresponding to a magnification of 10×.

The wall thickness of the microballoons was measured from the radiographs using a high resolution microscope (Olympus), ten measurements being carried out for each microballoon. These measurements made it possible to calculate a dispersion in the wall thickness that was ±2 μm for an average thickness of 112 μm, or a concentricity of 97%.

For the tests for assessing the density, the microballoons were weighed using an ultraprecision balance accurate to 1 μg. The volume of the microballoons was determined using the data previously recovered using the telecentric microscope and the X-ray radiographs. These tests showed that the micro-balloons had a density of 240±10 mg/cm⁻³.

The structure of the microballoons was, itself, assessed using a scanning electron microscope (a LEO 1525 SEM).

FIG. 6 represents three images thus obtained on a microballoon, at a magnification of 40 000×, the part A corresponding to the external surface of the wall of this microballoon, the part B corresponding to the transverse cross-sectional view of the wall and the part C corresponding to the internal surface of this wall.

These images demonstrate that there is good homogeneity of the structure between the internal surface, external surface and wall of the microballoons.

The invention is not limited to the embodiments and the implementation that have just been expressly described.

In particular, it is quite possible to produce polymer foam microbeads using a device and by a method that are similar to those described above, it being understood that in this case the aqueous phase W₁ is not used and that it is sufficient to use a two-phase injector instead of a three-phase injector 2.

1-23. (canceled)

24. A method for manufacturing polymer foam beads or balloons, comprising the following steps:
a) forming liquid beads with an organic phase, or liquid balloons by encapsulating an aqueous phase W₁ in an organic phase, this organic phase comprising at least one crosslinkable monomer and one initiator for polymerization in solution in an organic solvent immiscible with water;
b) forming an emulsion by suspending the liquid beads or balloons in an aqueous phase W₂;
c) subjecting the emulsion thus formed to a temperature θ that is at least equal to the temperature at which the polymerization initiator has a decomposition half-life of 5 to 15 minutes, but that is lower than the degradation temperature of the organic phase, for the time required for this organic phase to gel; and
d) completing the solidification of the organic phase of said beads or balloons.

25. The method as claimed in claim 24, in which step c) is carried out by making the emulsion flow in a duct (4) heated to the temperature θ.

26. The method as claimed in claim 24, in which, in step b), the liquid beads or balloons are suspended in the aqueous phase W₂ while being separated from each other by an aqueous phase W₂ volume.

27. The method as claimed in claim 26, in which, in step c), the liquid beads or balloons in suspension in the aqueous phase W₂ are kept separate from each other by an aqueous phase W₂ volume.

28. The method as claimed in claim 24, in which, in step a), the liquid beads or balloons are formed in successive order at the outlet orifice (25) of an injection system (20), whereas in step b), they are suspended in the aqueous phase W₂ by extraction from this orifice, as they are being formed, by means of an aqueous phase W₂ stream having a constant flow rate.

29. The method as claimed in claim 28, in which step c) is carried out by making the emulsion resulting from the extraction of said liquid beads or balloons flow via the aqueous phase W₂ stream in a duct heated to the temperature θ.

30. The method as claimed in claim 25, in which step d) is carried out in a container (6) into which the emulsion pours out after having traveled through said duct (4).

31. The method as claimed in claim 24, which comprises, in addition, after step d), a step of washing and a step of drying the beads or balloons.

32. The method as claimed in claim 31, in which, between the washing and drying steps, the organic solvent present within the wall of the beads or balloons is replaced with a solvent that is more volatile than water.

33. The method as claimed in claim 32, in which, for manufacturing balloons, the aqueous phase W₁ present in the balloons is also replaced with the solvent that is more volatile than water.

34. The method as claimed in claim 24, in which drying of the beads or balloons is carried out with supercritical CO₂.

35. The method as claimed in claim 24, in which, for manufacturing beads, the aqueous phase W₂ has a density that is at most 1% greater than the density of the organic phase.

36. The method as claimed in claim 24, in which, for manufacturing balloons, the aqueous phase W₂ has a density that is at most 1% greater than the density of the group formed by the organic phase and aqueous phase W₁, while the organic phase has a density that is at most 1% greater than the density of the aqueous phase W₁.

37. The method as claimed in claim 24, in which the polymerization of the crosslinkable monomer(s) present in the organic phase is of radical type.

38. The method as claimed in claim 37, in which the crosslinkable monomer(s) is(are) chosen from multifunctional acrylates and methacrylates.

39. The method as claimed in claim 36, in which the polymerization initiator is chosen from azo-type radical polymerization initiators that are soluble in organic solvents.

40. A device (1) for implementing a method as claimed in claim 1, comprising:
an injection system (20) comprising one or more inlets (21, 23) for supplying it with organic phase and optionally with aqueous phase W₁, and an outlet orifice (25) for forming the liquid beads or balloons;
a closed chamber (26) in which the outlet orifice (25) of the injection system (20) is housed, this chamber comprising one or more inlets for supplying it with aqueous phase W₂ and an outlet (30) for evacuating from this chamber the emulsion resulting from the suspension of the liquid beads or balloons in this aqueous phase W₂;
a coil (4) for subjecting the emulsion to the temperature θ, this coil comprising an inlet (42) connected to the chamber outlet and an outlet (43), and being equipped with heating means (5); and
means (6) for receiving the emulsion at the outlet of said coil.

41. The device as claimed in claim 40, in which the coil (4) is formed by a tube (40) wound spirally around a vertical axis (41), the turns of which are optionally touching.

42. The device as claimed in claim 40, in which the outlet (30) of the chamber is composed of tubing of which one end (31) is located opposite and close to the outlet orifice of the injection system, and of which the other end (32) is connected to the coil.

43. The device as claimed in claim 40, in which the coil (4) is housed within a closed chamber (5) equipped with an inlet (50) and an outlet (51) for supplying it with a heat transfer fluid.

44. The device as claimed in claim 43, in which the coil (4) and the chamber (5) are made of glass.
